(19) United States
(12) Patent Application Publication
(10) Pub. No.: US 2014/0143240 A1
(43) Pub. Date: May 22, 2014

(54) INFORMATION SEARCH SERVER AND INFORMATION SEARCH METHOD THEREOF

(71) Applicant: INSTITUTE FOR INFORMATION INDUSTRY, Taipei (TW)

(72) Inventors: Yu-Chee TSENG, Hsinchu City (TW); Chih-Yu LIN, Taipei City (TW); Jia-Ming LIANG, Guishan Township (TW); You-Ren CHU, New Taipei City (TW); Chien-Yi LI, New Taipei City (TW); Hsin-Yu CHANG, Kaohsiung City (TW); Chih-Yang CHUANG, Taipei City (TW); Chih-Chiang HSIEH, Taipei City (TW)

(73) Assignee: INSTITUTE FOR INFORMATION INDUSTRY, Taipei (TW)

(21) Appl. No.: 13/769,347

(22) Filed: Feb. 17, 2013

(30) Foreign Application Priority Data
Nov. 21, 2012 (TW) 101143484

(51) Int. Cl. G06F 17/30

(52) U.S. Cl. CPC G06F 17/30539
USPC 707/724; 707/776

(57) ABSTRACT

An information search server and an information search method thereof are provided. The information search server includes a transceiver and a processor. The transceiver receives a search message having an original store phone number of an original store from a user device. The processor performs a data mining procedure, according to the original store phone number, to obtain an original store name and an original store address associated with the original store phone number, a category associated with the original store name, an original store latitude and longitude associated with the original store address, and a recommended store information associated with the category and the original store latitude and longitude, and generates a result message having the recommended store information. The transceiver further transmits the result message to the user device.

### PRIORITY

This application claims the benefit of priority based on Taiwan Patent Application No. 101143484 filed on Nov. 21, 2012, which is hereby incorporated by reference herein in its entirety.

### FIELD

The present invention relates to an information search server and an information search method thereof. More particularly, the information search server of the present invention can receive a search message having a phone number of a store from a user device, mine similar stores near the store according to the phone number of the store, and then return a result message having information of the similar stores to the user device.

### BACKGROUND

With steady advancement of the mobile communication technologies and widespread use of smart mobile phones, people can now use their smart mobile phones to search for necessary information from the Internet any time and anywhere. In people's daily life, the most common application of this is to search for information of hotels, restaurants, rental houses, theaters or shops.

However, these searching operations are all targeted to designated stores to obtain their information. Therefore, when a user fails to obtain the necessary service from a designated store, he must alter the searching conditions again to obtain information of another designated store. For example, when the user wants to have a meal in a specific region, he may search for a restaurant through use of his smart mobile phone to get a phone number of the restaurant, and then dial the phone number of the restaurant to make a reservation. However, if the restaurant has already been fully reserved and no seat is available for the user, the user must search for another restaurant in this specific region through use of his smart mobile phone again to get a phone number and make a reservation. If such complex procedures have to be carried out repeatedly, the user might loose his patience, and this will reduce the user's desire to use the smart mobile phone for information searching.

Accordingly, an urgent need exists in the art to provide a convenient mechanism of searching for store information so that related store information can be obtained quickly through use of a smart mobile phone.

### SUMMARY

An objective of the present invention is to provide an information search server and an information search method thereof. When a user dials a phone number of a store through use of a smart mobile phone, the information search server of the present invention will receive a search message having the phone number of the store from the smart mobile phone, and mine similar stores near the store from the Internet according to the phone number so as to return a result message having information of the similar stores to the user device. Thus, when the user fails to obtain the necessary service from the store whose phone number is originally dialed, the user can obtain the information of the nearby similar stores directly without the need of carrying out complex searching operations because the information search server of the present invention has already provided the information of the nearby similar stores to the smart mobile phone in real time.

To achieve the aforesaid objective, certain embodiments of the present invention disclose an information search server, which comprises a transceiver and a processor. The transceiver is configured to receive a search message from a user device. The search message has an original store phone number of an original store. The processor is electrically connected to the transceiver, and is configured to perform a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude. The transceiver is further configured to transmit a result message having the recommended store information to the user device.

Furthermore, certain embodiments of the present invention further disclose an information search method for an information search server. The information search server comprises a transceiver and a processor electrically connected to the transceiver. The information search method is executed by the processor and comprises the following steps: receiving a search message from a user device via the transceiver, the search message having an original store phone number of an original store; performing a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude; and transmitting a result message having the recommended store information to the user device via the transceiver.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 depicts message transmissions between an information search server 1 and a user device 3 according to a first embodiment of the present invention;

FIG. 2 is a schematic view of the information search server 1 according to the first embodiment of the present invention;

FIG. 3 is a schematic view of an information search server 2 according to a second embodiment of the present invention;

FIG. 4 depicts message transmissions between the information search server 1 and the user device 3, a store information server 5, a geographic location information server 7 as well as a local information server 9 according to a third embodiment of the present invention;

FIG. 5 is a flowchart diagram of an information search method according to a fourth embodiment of the present invention;

FIG. 6A-FIG 6B are flowchart diagrams of an information search method according to a fifth embodiment of the present invention; and

FIG. 7A-FIG 7C are flowchart diagrams of an information search method according to a sixth embodiment of the present invention.

### DETAILED DESCRIPTION

The present invention will be explained with reference to the following example embodiments thereof. However, these example embodiments are not intended to limit the present invention to any specific examples, embodiments, environments, applications or implementations described in these embodiments. Therefore, description of these embodiments is only for purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

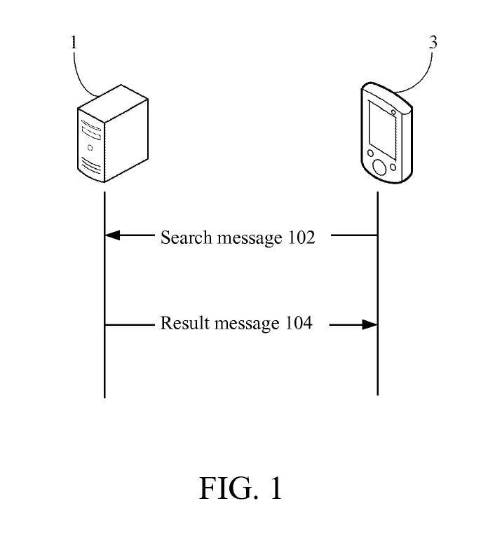

A first embodiment of the present invention is as shown in FIG. 1, which depicts message transmissions between an information search server 1 and a user device 3. The user device 3 transmits a search message 102 to the information search server 1. The search message 102 has an original store phone number of an original store. The information search server 1 mines similar stores near the original store from the Internet according to the original store phone number to return a result message having recommended store information to the user device 3. It shall be appreciated that, in this embodiment, it is when a user dials the original store phone number through use of the user device 3 that the operation of transmitting the search message 102 by the user device 3 occurs, and the “original store” refers to a store having the phone number which is currently dialed by the user device.

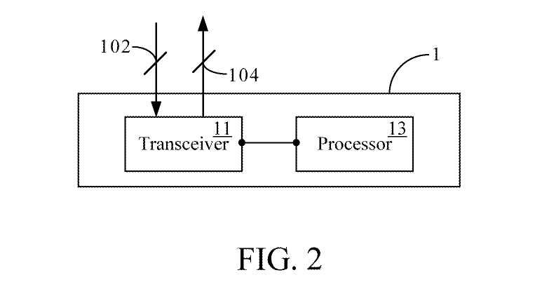

Specifically, as shown in FIG. 2, the information search server 1 of the present invention comprises a transceiver 11 and a processor 13. The processor 13 is electrically connected to the transceiver 11. After the search message 102 is received by the transceiver 11 from the user device 3, the processor 13 performs a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude.

Then, the processor 13 generates the result message 104 having the recommended store information. Next, the transceiver 11 transmits the result message 104 to the user device 3. Accordingly, after the result message 104 is received by the user device 3 from the information search server 1, the user can select his favorite store information from the recommended store information comprised in the result message 104.

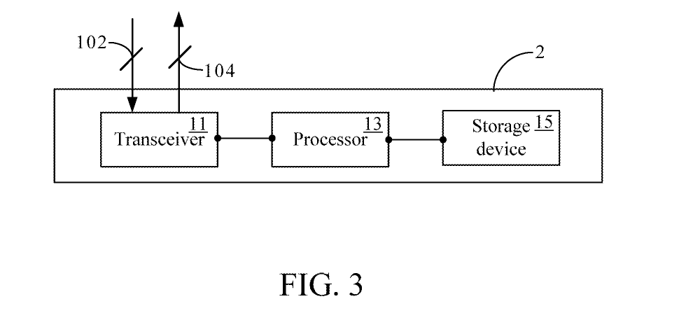

A second embodiment of the present invention is as shown in FIG. 3, which is a schematic view of an information search server 2. Different from the information search server 1 of the first embodiment, the information search server 2 of this embodiment further comprises a storage device 15 which stores a database. The database comprises various store information such as phone numbers, names, addresses, and latitudes and longitudes. The processor 13 is electrically connected to the storage device 15. The data mining procedure performed by the processor 13 is as follows.

Firstly, the processor 13 reads the original store name and the original store address associated with the original store phone number from the storage device 15 according to the original store phone number. Then, the processor 13 categorizes the original store according to the original store name to obtain the category associated with the original store name. In this embodiment, the category may comprise at least one of a hotel, a restaurant, a rental house, a theater and a shop. For example, if the store name comprises a word “hotel”, then the category associated with the store name is the hotel, which will be called the category A for subsequent description.

The processor 13 reads the original store latitude and longitude associated with the original store address from the storage device 15 according to the original store address, and reads nearby store information of a plurality of nearby stores from the storage device according to the original store latitude and longitude. Each of the plurality of pieces of nearby store information comprises a nearby store name, a nearby store address and a nearby store latitude and longitude. The aforesaid nearby stores refer to stores that have a distance smaller than a specific value (e.g., 500 meters, 1 kilometer, 1.5 kilometers, or the like) from the original store. The specific value may be set according to specific countries or regions, and is not intended to limit the scope of the present invention.

Then, the processor 13 filters the plurality of pieces of nearby store information according to the category A to generate a recommended store name(s), a recommended store address(es) and a recommended store latitude(s) and longitude(s) of one or more recommended stores. In detail, the processor 13 filters the nearby store names in the plurality of pieces of nearby store information by using at least one keyword (e.g., “hotel”, “restaurant”, “coffee”, “Japanese food” or the like) and according to the category A so as to obtain the recommended store name(s), the recommended store address(es) and the recommended store latitude(s) and longitude(s) of one or more recommended stores. Thus, the one or more recommended stores obtained through the filtering operation belong to the same category as the original store.

Then, the processor 13 reads a recommended store phone number(s) of the one or more recommended stores from the storage device 15 according to the recommended store name(s) of the one or more recommended stores, and calculates a recommended store distance(s) between the original store and the one or more recommended stores according to the original store latitude and longitude and the recommended store latitude(s) and longitude(s). Finally, the processor 13 generates the recommended store information, which comprises the recommended store name(s), the recommended store phone number(s), the recommended store address(es) and the recommended store distances of the one or more recommended stores.

Accordingly, after the result message 104 is received by the user device 3 from the information search server 2, the user can select his favorite store information from the recommended store information comprised in the result message 104. Furthermore, the processor 13 may sort contents of the recommended store information according to the recommended store distance(s), so the user can read the information of the one or more recommended stores in sequence from the user device 3 according to the distance(s) between the one or more recommended stores and the original store.

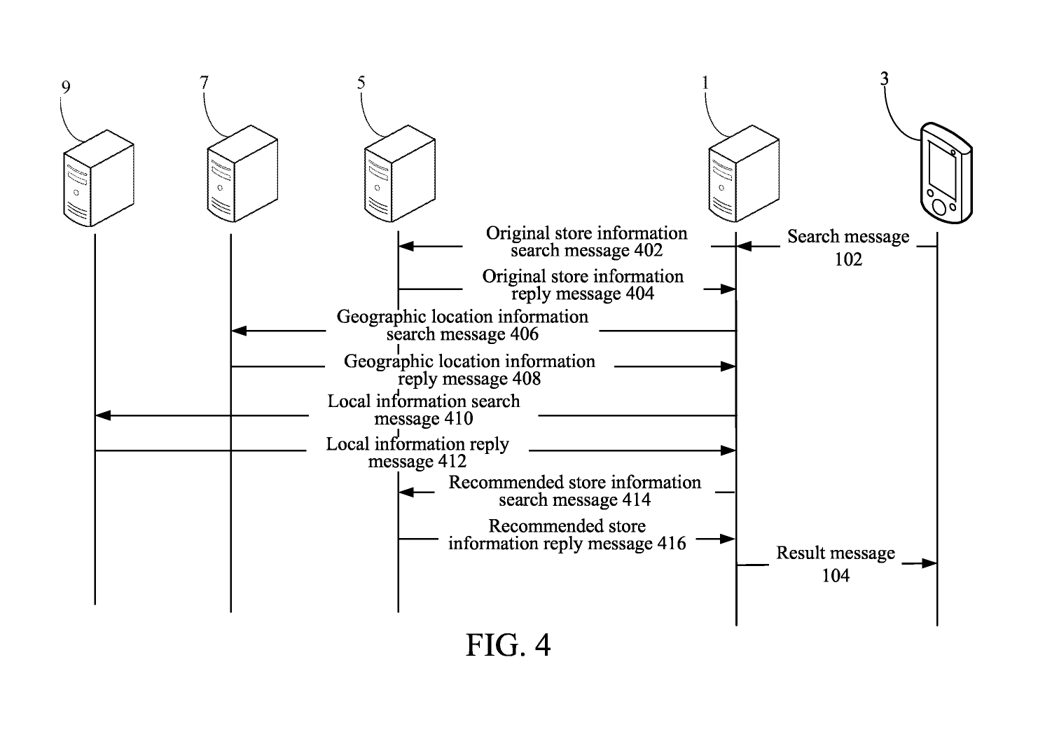

A third embodiment of the present invention is as shown in FIG. 4, which depicts message transmissions between the information search server 1 and the user device 3, a store information server 5, a geographic location information server 7 as well as a local information server 9. The search server 1 communicatively connects to the store information server, the geographic location information server and the local information server in a wired or wireless way. The store information server 5 stores phone numbers, names and addresses of various stores. The geographic location information server 7 stores latitudes and longitudes corresponding to the addresses (e.g., Google Geocoder). The local information server 9 stores names, addresses, and latitudes and longitudes of various stores (e.g., Google Places). The data mining procedure performed by the processor 13 is as follows.

When the user desires to dial the original store phone number through use of the user device 3, the user device 3 transmits the search message 102 having the original store phone number to the information search server 1. Then, the processor 13 generates an original store information search message 402 having the original store phone number according to the original store phone number, and transmits the original store information search message 402 to the store information server 5 via the transceiver 11.

The store information server 5 reads the original store name and the original store address corresponding to the original store phone number carried in the original store information search message 402 according to the original store phone number, and generates an original store information reply message 404 having the original store name and the original store address associated with the original store phone number. Then, the store information server 5 transmits the original store information reply message 404 to the information search server 1.

Subsequently, after receiving the original store information reply message 404 from the store information server 5 via the transceiver 11, the processor 13 categorizes the original store according to the original store name to obtain the category associated with the original store name. Similarly, in this embodiment, the category may comprise at least one of a hotel, a restaurant, a rental house, a theater and a shop. For example, if the store name comprises a word “hotel”, then the category associated with the store name is the hotel, which will be called the category A for subsequent description.

Then, the processor 13 generates a geographic location information search message having the original store address according to the original store address, and transmits the geographic location information search message 406 to the geographic location information server 7 via the transceiver 11. After receiving the geographic location information search message 406, the geographic location information server 7 generates a geographic location information reply message 408 having the original store latitude and longitude associated with the original store address according to the original store address, and transmits the geographic location information reply message 408 to the information search server 1.

The processor 13 receives the geographic location information reply message 408 from the geographic location information server 7 via the transceiver 11. The geographic location information reply message 408 has the original store latitude and longitude associated with the original store address. Then, the processor 13 generates a local information search message 410 having the original store latitude and longitude according to the original store latitude and longitude, and transmits the local information search message 410 to the local information server 9 via the transceiver 11.

After receiving the local information search message 410, the local information server 9 reads nearby store information of a plurality of nearby stores according to the original store latitude and longitude. Each of the plurality of pieces of nearby store information comprises a nearby store name, a nearby store address and a nearby store latitude and longitude. The aforesaid nearby stores refer to stores that have a distance smaller than a specific value (e.g., 500 meters, 1 kilometer, 1.5 kilometers, or the like) from the original store. Then, the local information server 9 generates a local information reply message 412 having the plurality of pieces of nearby store information, and transmits the local information reply message 412 to the information search server 1.

The processor 13 receives the local information reply message 412 from the local information server 9 via the transceiver 11, and then filters the plurality of pieces of nearby store information according to the category A to generate a recommended store name(s), a recommended store address(es) and a recommended store latitude(s) and longitude(s) of one or more recommended stores. In detail, the processor 13 filters the nearby store names in the plurality of pieces of nearby store information by using at least one keyword (e.g., “hotel”, “restaurant”, “coffee”, or “Japanese food”) and according to the category A so as to generate the recommended store name(s), the recommended store address(s) and the recommended store latitude(s) and longitude(s) of one or more recommended stores. Thus, the one or more recommended stores selected through the filtering operation belong to the same category as the original store.

Then, the processor 13 generates a recommended store information search message 414 having the recommended store name(s) of the one or more recommended stores according to the recommended store name(s) of the one or more recommended stores, and transmits the recommended store information search message 414 to the store information server 5. The store information server 5 reads a recommended store phone number(s) corresponding to the one or more recommended stores according to the recommended store name(s) carried in the recommended store information search message 414, and generates a recommended store information reply message 416 having the recommended store phone number(s). Then, the store information server 5 transmits the recommended store information reply message 416 to the information search server 1.

After receiving the recommended store information reply message 416 from the store information server 9 via the transceiver 11, the processor 13 calculates a recommended store distance(s) between the original store and the one or more recommended stores according to the original store latitude and longitude and the recommended store latitude(s) and longitude(s). Finally, the processor 13 generates the recommended store information, which comprises the recommended store name(s), the recommended store phone number(s), the recommended store address(es) and the recommended store distance(s) of the one or more recommended stores.

Accordingly, after the result message 104 is received by the user device 3 from the information search server 1, the user can select his favorite store information from the recommended store information comprised in the result message 104. Furthermore, the processor 13 may sort contents of the recommended store information according to the recommended store distance(s), so the user can read the information of the one or more recommended stores in sequence from the user device 3 according to the distance(s) between the one or more recommended stores and the original store.

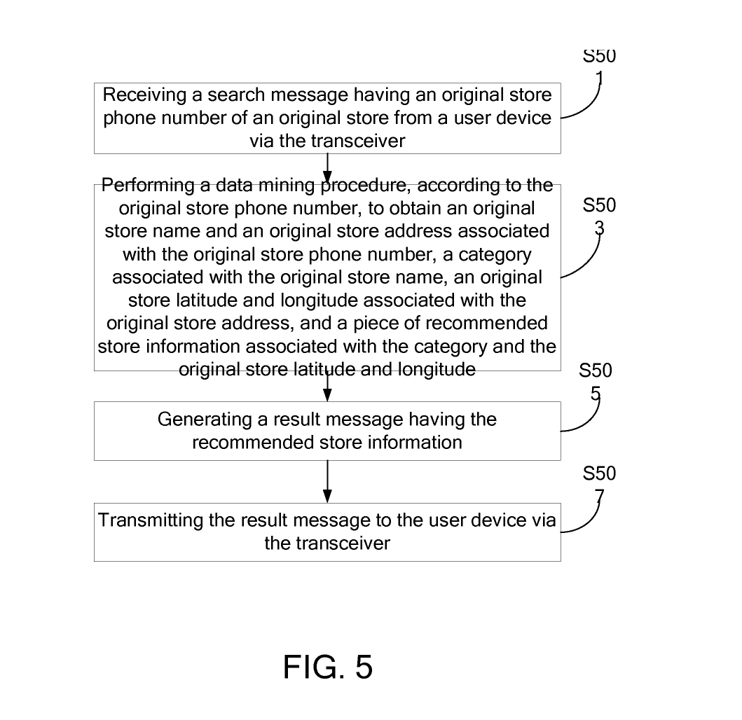

A fourth embodiment of the present invention is as shown in FIG. 5, which is a flowchart diagram of an information search method. The information search method of this embodiment can be used in an information search server (e.g., the information search server 1 of the first embodiment). The information search server comprises a transceiver and a processor electrically connected to the transceiver. The information search method of this embodiment is executed by the processor of the information search server.

Firstly, step S501 is executed to receive a search message from a user device via the transceiver. The search message has an original store phone number of an original store. Then, step S503 is executed to perform a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude.

Then, step S505 is executed to generate a result message having the recommended store information. Finally, step S507 is executed to transmit the result message to the user device via the transceiver. Thus, after the result message is received by the user device, the user can select his favorite store information from the recommended store information.

In addition to the aforesaid steps, the information search method of this embodiment can also execute all the operations set forth in the first embodiment and have all the corresponding functions. How the information search method of this embodiment executes these operations and has these functions can be readily appreciated by those of ordinary skill in the art based on the explanation of the first embodiment, and thus will not be further described herein.

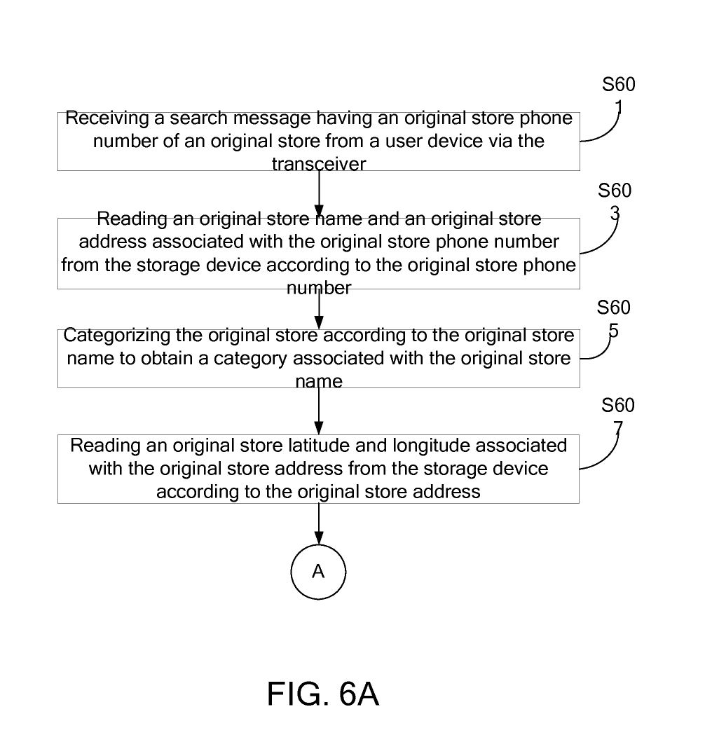

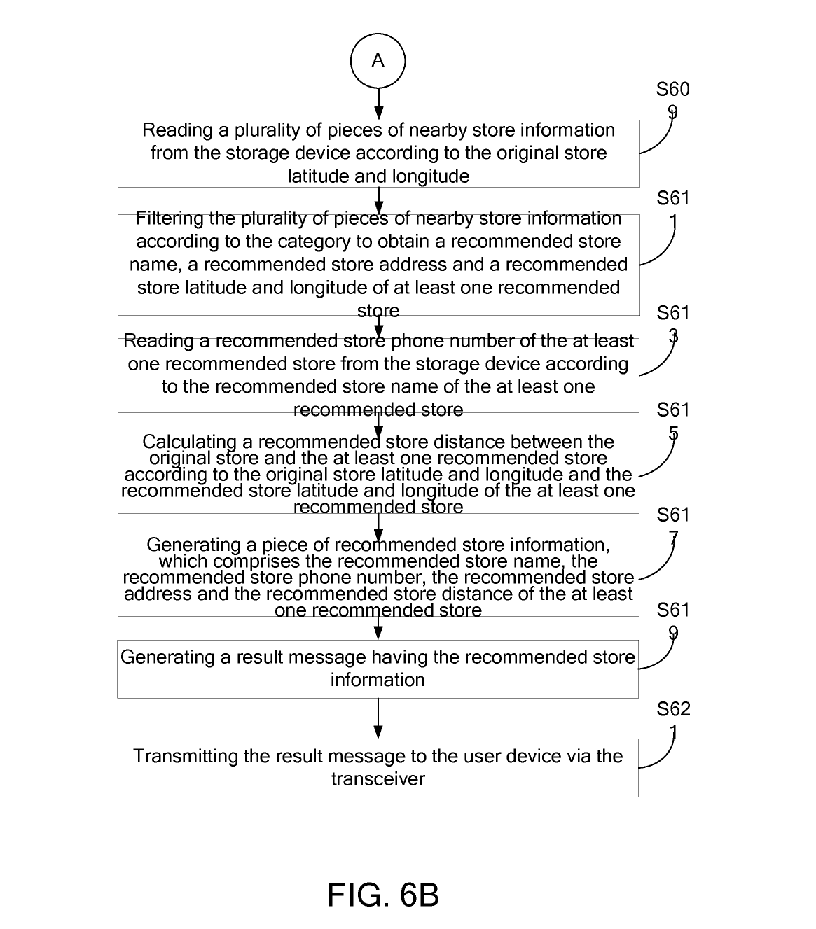

A fifth embodiment of the present invention is as shown in FIG. 6A-FIG 6B, which are flowchart diagrams of an information search method. The information search method of this embodiment can be used in an information search server (e.g., the information search server 2 of the second embodiment). The information search server comprises a transceiver, a storage device, and a processor electrically connected to the transceiver and the storage device. The storage device stores a database, which comprises various store information such as phone numbers, names, addresses, and latitudes and longitudes. The information search method of this embodiment is executed by the processor of the information search server.

Firstly, step S601 is executed to receive a search message from a user device via the transceiver. The search message has an original store phone number of an original store. Then, step S603 is executed to read an original store name and an original store address associated with the original store phone number from the storage device according to the original store phone number.

Then, step S605 is executed to categorize the original store according to the original store name to obtain a category associated with the original store name. Step S607 is executed to read an original store latitude and longitude associated with the original store address from the storage device according to the original store address. Then, step S609 is executed to read a plurality of pieces of nearby store information from the storage device according to the original store latitude and longitude. Each of the plurality of pieces of nearby store information comprises a nearby store name, a nearby store address and a nearby store latitude and longitude.

Step S611 is executed to filter the plurality of pieces of nearby store information according to the category to obtain a recommended store name, a recommended store address and a recommended store latitude and longitude of at least one recommended store. Step S613 is executed to read a recommended store phone number of the at least one recommended store from the storage device according to the recommended store name of the at least one recommended store.

Then, step S615 is executed to calculate a recommended store distance between the original store and the at least one recommended store according to the original store latitude and longitude and the recommended store latitude and longitude of the at least one recommended store. Then, step S617 is executed to generate a piece of recommended store information, which comprises the recommended store name, the recommended store phone number, the recommended store address and the recommended store distance of the at least one recommended store.

Step S619 is executed to generate a result message having the recommended store information. Finally, step S621 is executed to transmit the result message to the user device via the transceiver. Thus, after the result message is received by the user device, the user can select his favorite store information from the recommended store information.

In addition to the aforesaid steps, the information search method of this embodiment can also execute all the operations set forth in the second embodiment and have all the corresponding functions. How the information search method of this embodiment executes these operations and has these functions can be readily appreciated by those of ordinary skill in the art based on the explanation of the second embodiment, and thus will not be further described herein.

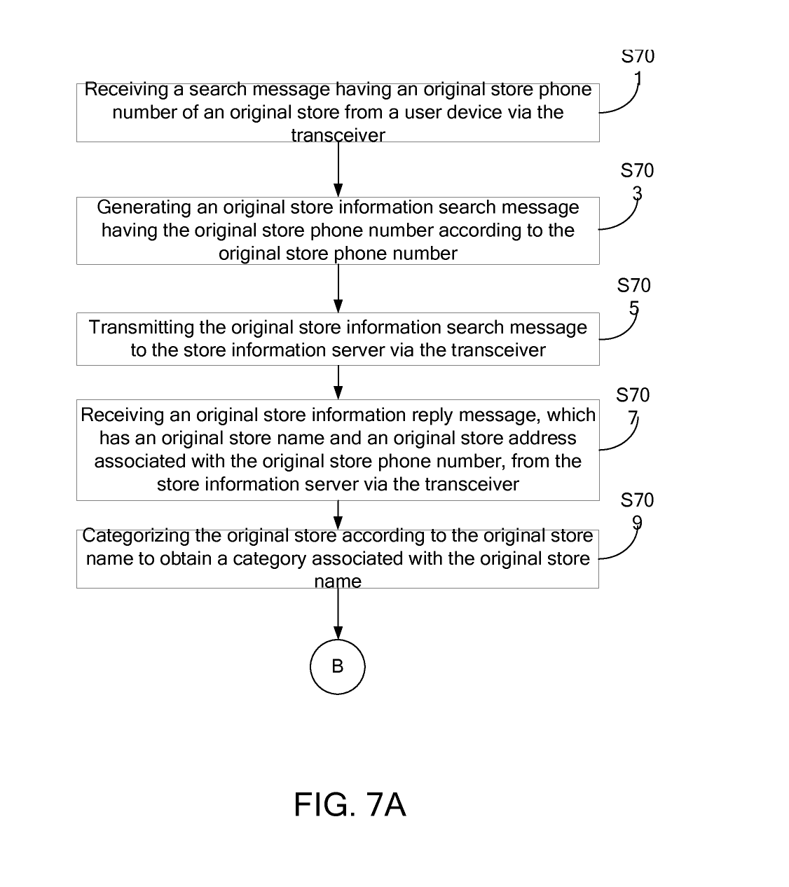

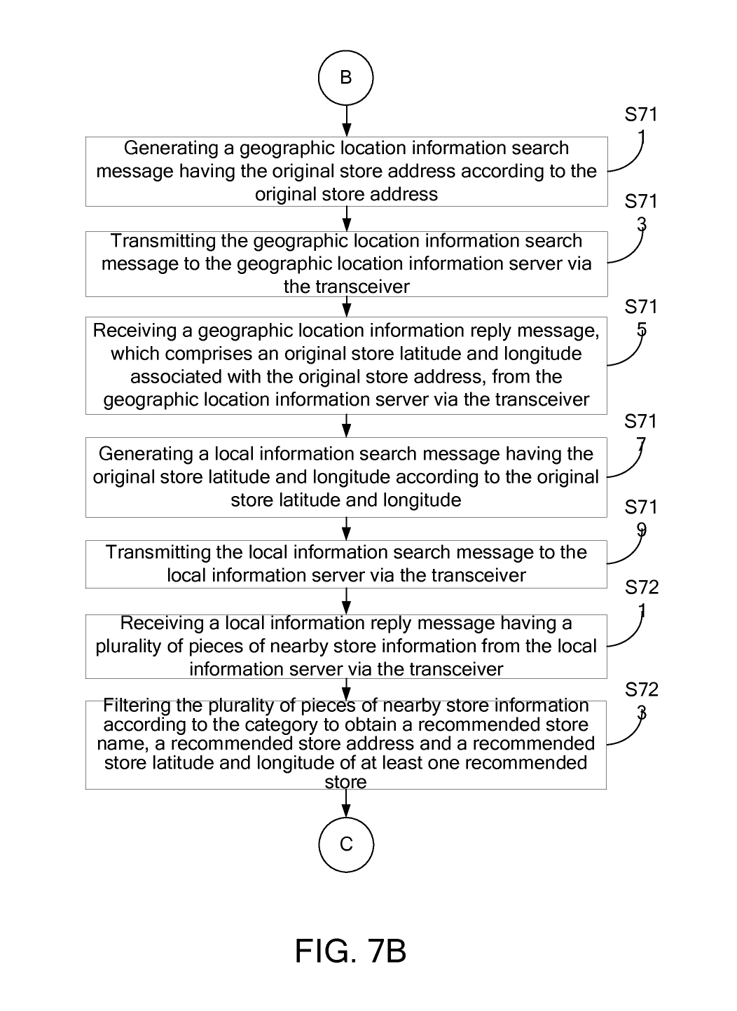

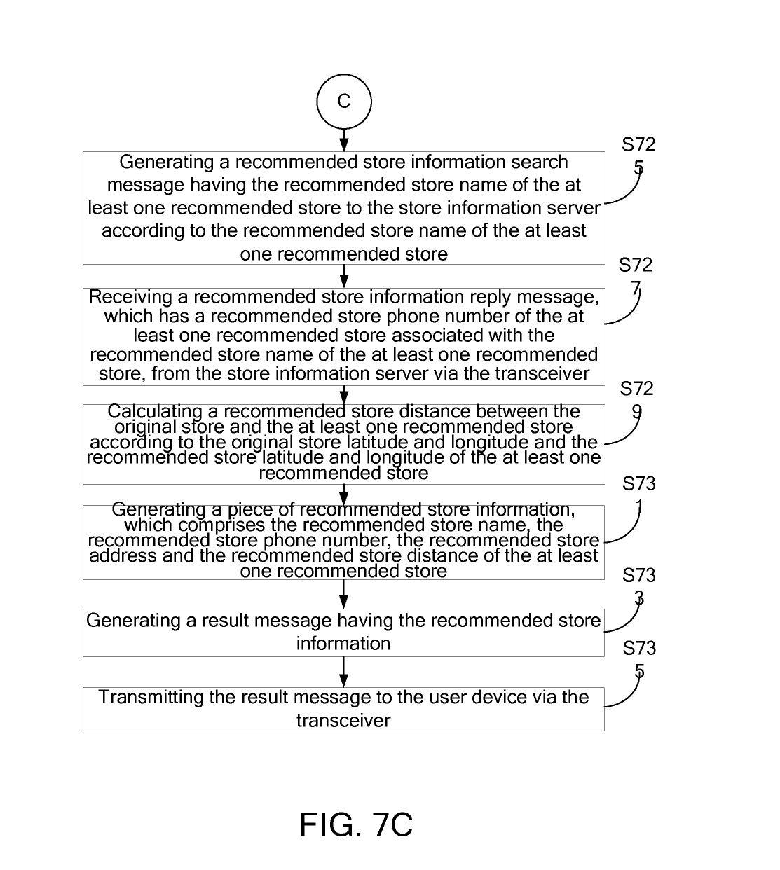

A sixth embodiment of the present invention is as shown in FIG. 7A-FIG 7C, which are flowchart diagrams of an information search method. The information search method of this embodiment can be used in an information search server (e.g., the information search server 1 of the third embodiment). The information search server comprises a transceiver and a processor electrically connected to the transceiver.

The search server communicatively connects to a store information server, a geographic location information server and a local information server in a wired or wireless way. The store information server stores phone numbers, names and addresses of various stores. The geographic location information server stores latitudes and longitudes corresponding to the addresses. The local information server stores names, addresses, and latitudes and longitudes of various stores. The information search method of this embodiment is executed by the processor of the information search server.

Firstly, step S701 is executed to receive a search message from a user device via the transceiver. The search message has an original store phone number of an original store. Then, step S703 is executed to generate an original store information search message having the original store phone number according to the original store phone number. Step S705 is executed to transmit the original store information search message to the store information server via the transceiver.

Then, step S707 is executed to receive an original store information reply message from the store information server via the transceiver, with the original store information reply message having an original store name and an original store address associated with the original store phone number. Step S709 is executed to categorize the original store according to the original store name to obtain a category associated with the original store name. Then, step S711 is executed to generate a geographic location information search message having the original store address according to the original store address.

Step S713 is executed to transmit the geographic location information search message to the geographic location information server via the transceiver. Step S715 is executed to receive a geographic location information reply message from the geographic location information server via the transceiver, with the geographic location information reply message comprising an original store latitude and longitude associated with the original store address. Then, step S717 is executed to generate a local information search message having the original store latitude and longitude according to the original store latitude and longitude. Then, step S719 is executed to transmit the local information search message to the local information server via the transceiver.

Step S721 is executed to receive a local information reply message having a plurality of pieces of nearby store information from the local information server via the transceiver. Each of the plurality of pieces of nearby store information comprises a nearby store name, a nearby store address and a nearby store latitude and longitude. Step S723 is executed to filter the plurality of pieces of nearby store information according to the category to obtain a recommended store name, a recommended store address and a recommended store latitude and longitude of at least one recommended store. Step S725 is executed to generate a recommended store information search message having the recommended store name of the at least one recommended store to the store information server according to the recommended store name of the at least one recommended store.

Step S727 is executed to receive a recommended store information reply message from the store information server via the transceiver, with the recommended store information reply message having a recommended store phone number of the at least one recommended store associated with the recommended store name of the at least one recommended store. Step S729 is executed to calculate a recommended store distance between the original store and the at least one recommended store according to the original store latitude and longitude and the recommended store latitude and longitude of the at least one recommended store. Step S731 is executed to generate a piece of recommended store information, which comprises the recommended store name, the recommended store phone number, the recommended store address and the recommended store distance of the at least one recommended store.

Step 5733 is executed to generate a result message having the recommended store information. Finally, step S735 is executed to transmit the result message to the user device via the transceiver. Thus, after the result message is received by the user device, the user can select his favorite store information from the recommended store information.

In addition to the aforesaid steps, the information search method of this embodiment can also execute all the operations set forth in the third embodiment and have all the corresponding functions. How the information search method of this embodiment executes these operations and has these functions can be readily appreciated by those of ordinary skill in the art based on the explanation of the third embodiment, and thus will not be further described herein.

According to the above descriptions, the information search server of the present invention can mine similar stores near a store from the Internet according to a search message having a phone number of the store received from a user device and according to the phone number, and return a result message having information of the similar stores to the user device. Thus, without the need of carrying out complex operations, the user can rapidly obtain the information of stores near the store whose phone number is dialed. On the other hand, by combining the information search server of the present invention with a plurality of information search servers to form an information sharing network, the integrated information searching function can be achieved to provide the user with a more convenient information search mechanism.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An information search server, comprising:
a transceiver, being configured to receive a search message from a user device, the search message having an original store phone number of an original store; and
a processor electrically connected to the transceiver, being configured to perform a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude, and generate a result message having the recommended store information;
wherein the transceiver is further configured to transmit the result message to the user device.

2. The information search server as claimed in claim 1, further comprising a storage device configured to store a database, wherein the processor is electrically connected to the storage device, and the data mining procedure performed by the processor comprises:
reading the original store name and the original store address associated with the original store phone number from the storage device according to the original store phone number;
categorizing the original store according to the original store name to obtain the category associated with the original store name;
reading the original store latitude and longitude associated with the original store address from the storage device according to the original store address;
reading a plurality of pieces of nearby store information from the storage device according to the original store latitude and longitude, each of the plurality of pieces of nearby store information comprising a nearby store name, a nearby store address and a nearby store latitude and longitude;
filtering the plurality of pieces of nearby store information according to the category to obtain a recommended store name, a recommended store address and a recommended store latitude and longitude of at least one recommended store;
reading a recommended store phone number of the at least one recommended store from the storage device according to the recommended store name of the at least one recommended store;
calculating a recommended store distance between the original store and the at least one recommended store according to the original store latitude and longitude and the recommended store latitude and longitude of the at least one recommended store; and
generating the recommended store information, which comprises the recommended store name, the recommended store phone number, the recommended store address and the recommended store distance of the at least one recommended store.

3. The information search server as claimed in claim 2, wherein the processor filters the nearby store names in the plurality of pieces of nearby store information by using at least one keyword and according to the category so as to obtain the recommended store name, the recommended store address and the recommended store latitude and longitude of the at least one recommended store.

4. The information search server as claimed in claim 1, wherein the search server communicatively connects to a store information server, a geographic location information server and a local information server, and the data mining procedure performed by the processor comprises:
generating an original store information search message having the original store phone number according to the original store phone number;
transmitting the original store information search message to the store information server via the transceiver;
receiving an original store information reply message from the store information server via the transceiver, the original store information reply message having the original store name and the original store address associated with the original store phone number;
categorizing the original store according to the original store name to obtain the category associated with the original store name;
generating a geographic location information search message having the original store address according to the original store address;
transmitting the geographic location information search message to the geographic location information server via the transceiver;
receiving a geographic location information reply message from the geographic location information server via the transceiver, the geographic location information reply message comprising the original store latitude and longitude associated with the original store address;
generating a local information search message having the original store latitude and longitude according to the original store latitude and longitude;
transmitting the local information search message to the local information server via the transceiver;
receiving a local information reply message from the local information server via the transceiver, the local information reply message having a plurality of pieces of nearby store information, each of which comprises a nearby store name, a nearby store address and a nearby store latitude and longitude;
filtering the plurality of pieces of nearby store information according to the category to obtain a recommended store name, a recommended store address and a recommended store latitude and longitude of at least one recommended store;
generating a recommended store information search message to the store information server according to the recommended store name of the at least one recommended store, the recommended store information search message having the recommended store name of the at least one recommended store;
receiving a recommended store information reply message from the store information server via the transceiver, the recommended store information reply message having a recommended store phone number of the at least one recommended store associated with the recommended store name of the at least one recommended store;
calculating a recommended store distance between the original store and the at least one recommended store according to the original store latitude and longitude and the recommended store latitude and longitude of the at least one recommended store; and
generating the recommended store information, which comprises the recommended store name, the recommended store phone number, the recommended store address and the recommended store distance of the at least one recommended store.

5. The information search server as claimed in claim 4, wherein the processor filters the nearby store names in the plurality of pieces of nearby store information by using at least one keyword and according to the category so as to obtain the recommended store name, the recommended store address and the recommended store latitude and longitude of the at least one recommended store.

6. The information search server as claimed in claim 1, wherein the category comprises at least one of a hotel, a restaurant, a rental house, a theater and a shop.

7. An information search method for an information search server, the information search server comprising a transceiver and a processor electrically connected to the transceiver, and the information search method being executed by the processor and comprising the following steps:
receiving a search message from a user device via the transceiver, the search message having an original store phone number of an original store;
performing a data mining procedure, according to the original store phone number, to obtain an original store name and an original store address associated with the original store phone number, a category associated with the original store name, an original store latitude and longitude associated with the original store address, and a piece of recommended store information associated with the category and the original store latitude and longitude;
generating a result message having the recommended store information; and
transmitting the result message to the user device via the transceiver.

8. The information search method as claimed in claim 7 wherein the information search server further comprises a storage device configured to store a database, the processor is electrically connected to the storage device, and the processor further executes the following steps to perform the data mining procedure:
reading the original store name and the original store address associated with the original store phone number from the storage device according to the original store phone number;
categorizing the original store according to the original store name to obtain the category associated with the original store name;
reading the original store latitude and longitude associated with the original store address from the storage device according to the original store address;
reading a plurality of pieces of nearby store information from the storage device according to the original store latitude and longitude, each of the plurality of pieces of nearby store information comprising a nearby store name, a nearby store address and a nearby store latitude and longitude;
filtering the plurality of pieces of nearby store information according to the category to obtain a recommended store name, a recommended store address and a recommended store latitude and longitude of at least one recommended store;
reading a recommended store phone number of the at least one recommended store from the storage device according to the recommended store name of the at least one recommended store;
calculating a recommended store distance between the original store and the at least one recommended store according to the original store latitude and longitude and the recommended store latitude and longitude of the at least one recommended store; and
generating the recommended store information, which comprises the recommended store name, the recommended store phone number, the recommended store address and the recommended store distance of the at least one recommended store.

9. The information search method as claimed in claim 8, wherein the step of filtering the plurality of pieces of nearby store information further comprises the following step:
filtering the nearby store names in the plurality of pieces of nearby store information by using at least one keyword and according to the category so as to obtain the recommended store name, the recommended store address and the recommended store latitude and longitude of the at least one recommended store.

10. The information search method as claimed in claim 7, wherein the search server communicatively connects to a store information server, a geographic location information server and a local information server, and the processor further executes the following steps to perform the data mining procedure: generating an original store information search message having the original store phone number according to the original store phone number;
transmitting the original store information search message to the store information server via the transceiver;
receiving an original store information reply message from the store information server via the transceiver, the original store information reply message having the original store name and the original store address associated with the original store phone number;
categorizing the original store according to the original store name to obtain the category associated with the original store name;
generating a geographic location information search message having the original store address according to the original store address;
transmitting the geographic location information search message to the geographic location information server via the transceiver;
receiving a geographic location information reply message from the geographic location information server via the transceiver, the geographic location information reply message comprising the original store latitude and longitude associated with the original store address;
generating a local information search message having the original store latitude and longitude according to the original store latitude and longitude;
transmitting the local information search message to the local information server via the transceiver;
receiving a local information reply message from the local information server via the transceiver, the local information reply message having a plurality of pieces of nearby store information, each of which comprises a nearby store name, a nearby store address and a nearby store latitude and longitude;
filtering the plurality of pieces of nearby store information according to the category to obtain a recommended store name, a recommended store address and a recommended store latitude and longitude of at least one recommended store;
generating a recommended store information search message to the store information server according to the recommended store name of the at least one recommended store, the recommended store information search message having the recommended store name of the at least one recommended store;
receiving a recommended store information reply message from the store information server via the transceiver, the recommended store information reply message having a recommended store phone number of the at least one recommended store associated with the recommended store name of the at least one recommended store;
calculating a recommended store distance between the original store and the at least one recommended store according to the original store latitude and longitude and the recommended store latitude and longitude of the at least one recommended store; and
generating the recommended store information, which comprises the recommended store name, the recommended store phone number, the recommended store address and the recommended store distance of the at least one recommended store.

11. The information search method as claimed in claim 10, wherein the step of filtering the plurality of pieces of nearby store information further comprises the following step:
filtering the nearby store names in the plurality of pieces of nearby store information by using at least one keyword and according to the category so as to obtain the recommended store name, the recommended store address and the recommended store latitude and longitude of the at least one recommended store.

12. The information search method as claimed in claim 7, wherein the category comprises at least one of a hotel, a restaurant, a rental house, a theater and a shop.
